(19) United States
(12) Patent Application Publication
(10) Pub. No.: US 2005/0268222 A1
(43) Pub. Date: Dec. 1, 2005

(54) Method of creating, processing and storing HTML documents

(76) Inventor: Kai Ming Cheng, Hong Kong (CN)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/853,752

(22) Filed: May 26, 2004

(51) Int. Cl. G06F 17/00

(52) U.S. Cl. 715/513

(57) ABSTRACT

A method of creating an HTML form allowing input of data is disclosed as including the steps of providing a blank editable HTML form with a number of form fields; editing the HTML form by changing the first form fields or inputting new form fields; and storing the edited HTML form. Data may be inputted into the HTML form by opening the HTML form; entering data into the HTML form in accordance with the fields; and changing the source of the HTML form in accordance with the data inputted into the HTML form. Data may be extracted from filled-in forms by receiving the filled-in HTML forms with filled-in form fields; setting a criterion for selection of filled-in HTML forms; sorting the filled-in HTML forms on the basis of the sorting criterion; and reading and extracting the data in the filled-in HTML forms which fulfill the sorting criterion.

### BACKGROUND OF THE INVENTION

Most computer applications include exchanges of data between different entities, which may be one the following scenarios:
(1) two individuals exchange messages through e-mail or an instant message system, e.g. ICQ;
(2) exchange of information between an individual (user) and computer system, e.g. in the case where a user enters a search criterion into a searching engine, e.g. Google®; or
(3) exchange of information between two computer systems.

In scenario (1) above, information is presented in an unstructured way, e.g. plain text, which can only be understood and interpreted by human beings, and is very difficult to be processed by computer programs. In case (2) above, the application will present the input forms and restrict the fields to be inputted. Information will be presented in a structured way, e.g. Hyper Text Transport Protocol (HTTP). The message used can only be used by the computer programs but not human beings. In case (3) above, the application must pre-define a protocol which describes the format of the fields, and the application prepares messages to exchange data between two applications on the basis of the protocol. An example in this case is XML messages which can only be read by appropriate programs of the computers. XML is the abbreviation for “Extensible Markup Language”, which allows designers to create their own customized tags, enabling the definition, transmission, validation, and interpretation of data between applications and between organizations.

However, in some situations, people may wish to exchange structured information by e-mail or instant message system. For example, a secretary who wants to organize a meeting with several colleague may send out e-mails to ask for their availability. When the reply e-mails are received, he/she has to read the e-mails one by one to decide on the best time slot for the meeting. Such a process can only be done manually as, in the absence of any pre-defined format, it is very difficult for a computer to extract information from free text.

Most documents in World Wide Web (generally abbreviated to “web”) are created in HTML, and most web applications use HTML filled-out forms to collect information and data. HTML is a standard coding convention and set of codes for attaching presentation and linking attributes to informational content within documents. During a document authoring stage, the HTML codes, which are generally called “tags”, are embedded within the informational content of the document. An HTML form is a special type of HTML document. Unlike an ordinary HTML document, a user of an HTML form is allowed to input information, e.g. via text fields, text area, checkboxes, radio buttons, etc., into the form and, when completed, the user may click a “Submit” button, whereby the form is sent to an associated server for processing. Currently, HTML form submission is conducted on the basis of HTTP in which a HTTP connection is set up between the client and the server. The information of the HTML forms are passed as HTTP requests and processed by a program residing on the server.

An HTML form can contain a wide range of HTML markup including several kinds of form fields, such as:
Input field for single line text fields, password fields, checkboxes, radio buttons, “Submit” and “Reset” buttons, hidden fields, file upload, image buttons, etc.;
Selected field for single or multiple choice menu; and
TextArea field for multi-line text fields.

HTML forms are used for capturing user data and most Internet users are already familiar with the HTML form. Such a form is easy to construct by employing text editor or web page editing tools, and provides a cost effective way for companies or individuals to collect data from others.

When the form is completed, the user can click a “Submit” button to send the form with the inputted information to a related server for processing. However, the form itself does not provide any way of checking the content of the form, e.g. whether the “compulsory” fields have been completed, or whether numerical data have been inputted into a particular field requiring numerical data, before the form is submitted to the related server. Any checking and processing which may be considered to be necessary has to take place in the server to which the form content is submitted. A server must therefore exist and server-side programming is required to handle the data submitted by the user. In addition, HTML forms can only be worked in an online mode, i.e. when the client browser is connected to the related web server. When a user fills in an HTML form, he/she has to submit the form data with Get/Post method to the web server running Common Gateway Interface (CGI) program.

It is thus an object of the present invention to provide a method of creating HTML forms in which the aforesaid shortcomings are mitigated, or at least to provide a useful alternative to the public.

### SUMMARY OF THE INVENTION

According to a first aspect of the present invention, there is provided a method of creating an HTML document allowing input of data, including the steps of providing a blank editable HTML document carrying at least a piece of editable information; editing said HTML document by editing said piece of editable information; and storing said edited HTML document.

According to a second aspect of the present invention, there is provided a computer program loadable into a data processing apparatus and executable to carry out a method of creating an HTML document allowing input of data, said method including the steps of providing a blank editable HTML document carrying at least a piece of editable information; editing said HTML document by editing said piece of editable information; and storing said edited HTML document.

According to a third aspect of the present invention, there is provided a method of inputting data into an HTML document carrying at least a piece of editable information, including the steps of opening said HTML document; entering data into said HTML document; and changing the source of said HTML document in accordance with the data inputted into said HTML document.

According to a fourth aspect of the present invention, there is provided a computer program loadable into a data processing apparatus and executable to carry out a method of inputting data into an HTML form with at least one form field, said method including the steps of opening said HTML document; entering data into said HTML document; and changing the source of said HTML document in accordance with the data inputted into said HTML document.

According to a fifth aspect of the present invention, there is provided a method of extracting data inputted into a plurality of HTML forms, including the steps of receiving said plurality of filled-in HTML forms each with at least one filled-in form field; setting at least one criterion for selection of filled-in HTML forms; sorting said plurality of filled-in HTML forms on the basis of said at least one criterion; and reading and extracting said data in said filled-in HTML forms which fulfill said sorting criterion.

According to a sixth aspect of the present invention, there is provided a computer program loadable into a data processing apparatus and executable to carry out a method of extracting data inputted into a plurality of HTML forms, said method including the steps of receiving said plurality of filled-in HTML forms each with at least one filled-in form field; setting at least one criterion for selection of filled-in HTML forms; sorting said plurality of filled-in HTML forms on the basis of said at least one criterion; and reading and extracting said data in said filled-in HTML forms which fulfill said sorting criterion.

### BRIEF DESCRIPTION OF THE DRAWINGS

Preferred embodiments of the present invention will now be described, by way of examples only, with reference to the accompanying drawings, in which:

FIG. 1 shows schematically the steps whereby an HTML form is created and stored in accordance with the present invention;

FIG. 2 shows schematically the steps whereby data is inputted into an HTML form created in accordance with the present invention;

FIG. 3 shows schematically the steps whereby data inputted into an HTML form created in accordance with the present invention is processed;

FIG. 4 shows a sample HTML form created in accordance with the present invention as presented on a data processing apparatus, e.g. a computer, before input of data;

FIG. 5 shows the HTML source of the form shown in FIG. 4;

FIG. 6 shows the HTML form shown in FIG. 4 after input of data;

FIG. 7 shows the HTML source of the form shown in FIG. 6;

FIG. 8 is a sample web page showing implementation of a computer software according to the present invention;

FIG. 9 is a chart showing the functions which can be performed on an HTML page created in accordance with the present invention;

FIG. 10 shows the steps whereby HTML components are inserted into the HTML form;

FIG. 11 shows the steps whereby HTML forms are validated and saved;

FIG. 12 is a flowchart showing the steps whereby an HTML form is created in accordance with the present invention;

FIG. 13 shows a graphic presentation of a blank HTML form created in accordance with the present invention;

FIG. 14 shows the HTML source of the blank HTML form shown in FIG. 13;

FIG. 15 is a flowchart showing the steps whereby an HTML form created in accordance with the present invention is filled;

FIG. 16 shows a graphic presentation of a filled-in version of the blank HTML form shown in FIG. 13;

FIG. 17 shows the HTML source of the filled-in HTML form shown in FIG. 16;

FIG. 18 is a flowchart showing the steps whereby data entered into an HTML form created in accordance with the present invention are extracted;

FIG. 19 is a table showing the data collected from three form fillers in response to an HTML form created in accordance with the present invention;

FIG. 20 shows the data in FIG. 19 as extracted and organized in XML format; and

FIG. 21 is a simplified syntax diagram of an HTML form according to the present invention.

### DETAILED DESCRIPTION OF THE PREFERRED EMBODIMENTS

It should be understood that although examples of the present invention will herebelow be described with reference to the creation, processing and storing of HTML forms, it is readily understood by persons skilled in the art that such can be implemented in the creation, processing and storing of HTML documents other than HTML forms, and the scope of protection should be thus interpreted accordingly.

A crucial feature of a method of creating an HTML form according to the present invention is that the relevant program resides on the client side for capturing inputted data and transforming the HTML form source code to contain the inputted data. The HTML form inputted with such data may then be saved in a local hard disk or file server, or be sent out by e-mail. The system also allows a user to extract the data inputted into the HTML forms, and to convert the data into popular data file format, e.g. MS Excel. By way of such an arrangement, HTML forms may be created, processed and stored without connection with a web server.

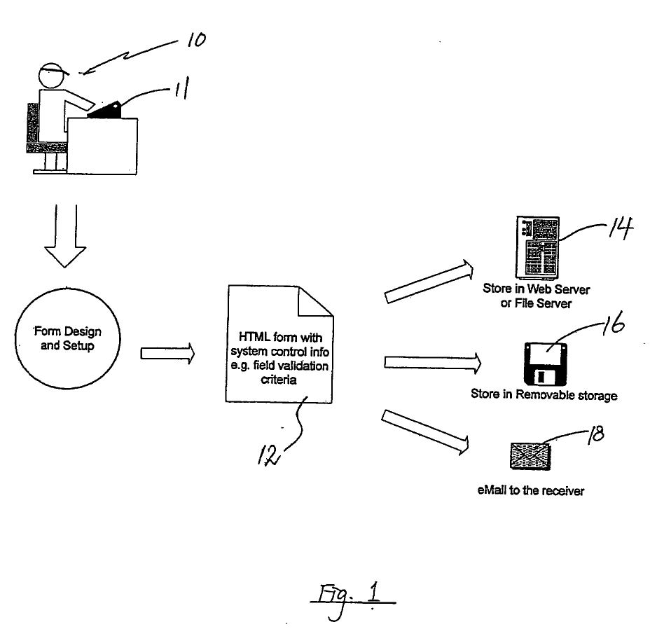

As shown in FIG. 1, a form creator 10 can design his/her own HTML form with a program in his/her data processing apparatus, e.g. computer 11. The HTML form may contain not only the input fields but also creator identity information, validation criteria of the input fields and optional information for information encryption. By virtue of such a method, a user may:
edit HTML templates or existing HTML file to create a new HTML form;
add user input tag, including checkbox control, option or radio button control, drop down box control, listbox control, textbox control, text area control, submit control, submit with image control, reset control, hidden control, and password control; and
add other publicly known standard tag formats.

The output HTML form is also in HTML file format.

In addition, by virtue of such a method, the form creator may:
add validation criteria related to the input fields, the validation criteria being stored as hidden fields;
add system control information, such as form ID, owner ID, digital signature, and creation date/time, with such system control information being stored as hidden fields; and
add encryption information used for content encryption.

A blank HTML form 12 so created and filled-in may then be stored in a web server, if the computer 11 of the form creator 10 is connected with a remote web server, or a file server 14 of the local computer 11. The HTML form 12 may also be stored in a removable data storage media 16, e.g. a floppy disk or tape. Alternatively, the form 12 may be transmitted by an e-mail message 18, or a completed mail object containing the form 12 may be generated. The important point is that the whole HTML form, together with the filled-in data if the form is completed, and related system information, e.g. user ID, are stored.

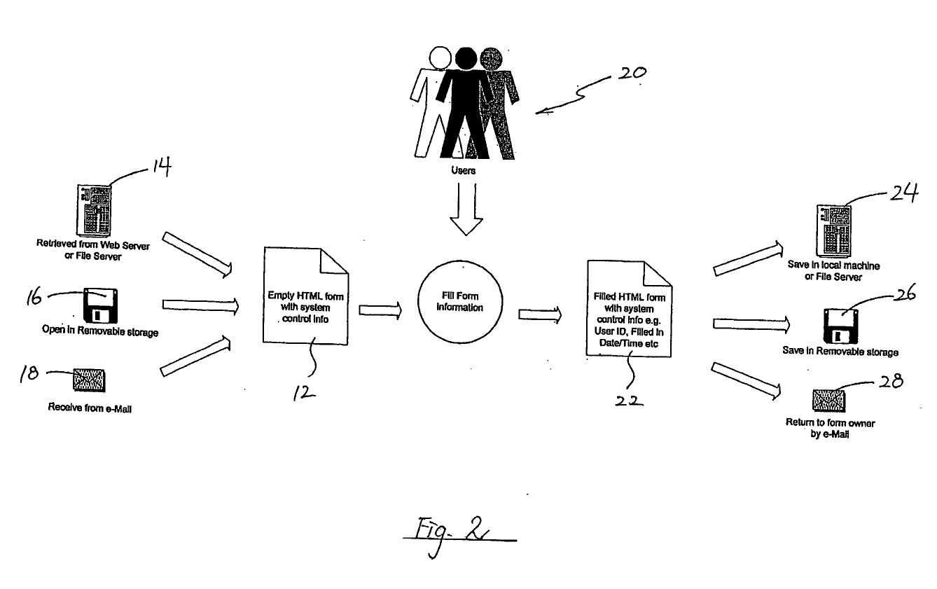

A form creator may send a blank HTML form 12 so created to various recipients. As shown in FIG. 2, the recipients (form fillers) 20 may input data into the HTML form 12 so received. The users 20 first retrieve an empty HTML form 12 with system control information from the web server/file server 14, the removable data storage media 16 or an e-mail message 18 containing the form 12. The users 20 may then input data into the HTML form 12 in accordance with instructions contained in the form 12 to produce a filled-in HTML form 22. By virtue of the method according to the present invention, a user may be requested to login, i.e. provide the necessary user ID and/or password before he/she is allowed access to the system. In such a method:
the HTML form system information is verified and the user is alerted if there is any discrepancy;
the filled-in HTML form 22 is converted to include the filled-in data, in a manner to be discussed in more detail below;
the inputted information is validated with the validation criteria specified in the HTML form 12;
system control information, such as user ID, event ID, digital signature and creation date/time are added, such system information be stored as hidden fields;
the user is allowed to perform encryption transformation in which the whole HTML page is encrypted and encoded as a string. In this case, the filled-in HTML form 22 will be replaced by an HTML form with one field only, which is the value containing the encrypted string.

Again, the filled-in HTML form 22 may then be stored as a whole in a local machine of the user(s) 20 or file server 24, a removable data storage media 26, e.g. a floppy disk or tape, or be transmitted by an e-mail message 28, or a completed mail object containing the filled-in form 22 may be generated.

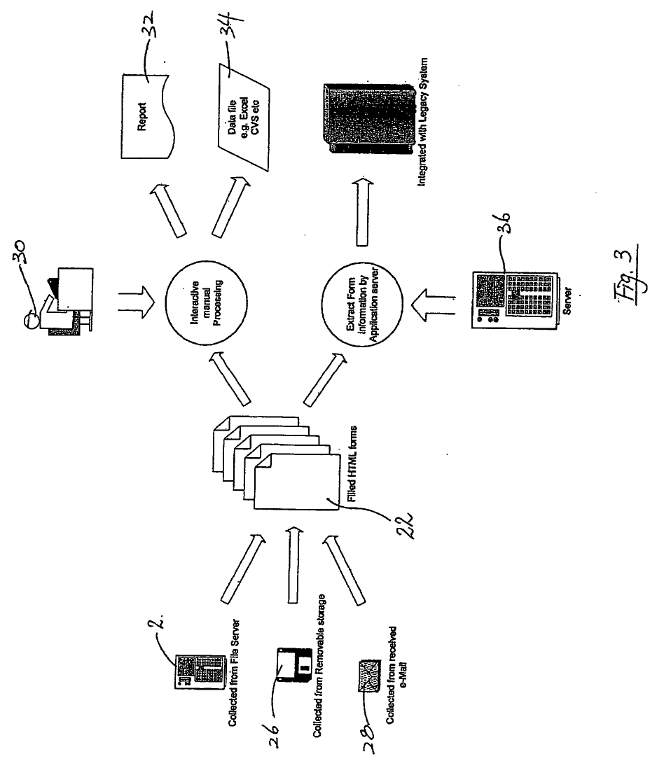

As shown in FIG. 3, filled-in HTML forms 22 collected from file server 24, removable data storage media 26, or e-mail 28 may then be processed either manually or digitally. When such forms 22 are processed manually, a form analyzer 30 may read and extract the information contained in the forms 22, and generate reports 32 and data files 34 in other popular data formats, e.g. MS Excel or Concurrent Versions System (CVS). The form analyzer 30 may view the filled-in information and group the information by user ID or form ID. When processed digitally, a data processing apparatus, e.g. a server 36, may process the filled-in forms 22 to retrieve the necessary information and data.

In the method according to this invention, HTML forms, i.e. a regular HTML page with tag <FORM></FORM>, are used for exchange of information. Simply stated, HTML defines the structure and layout of a Web document by using a variety of tags and attributes. The correct structure for an HTML document starts with <HTML><HEAD>(enter what the document is about)</HEAD><BODY> and ends with </BODY></HTML>. All the information to be included in the Web page is to be inserted between the <BODY>and </BODY> tags.

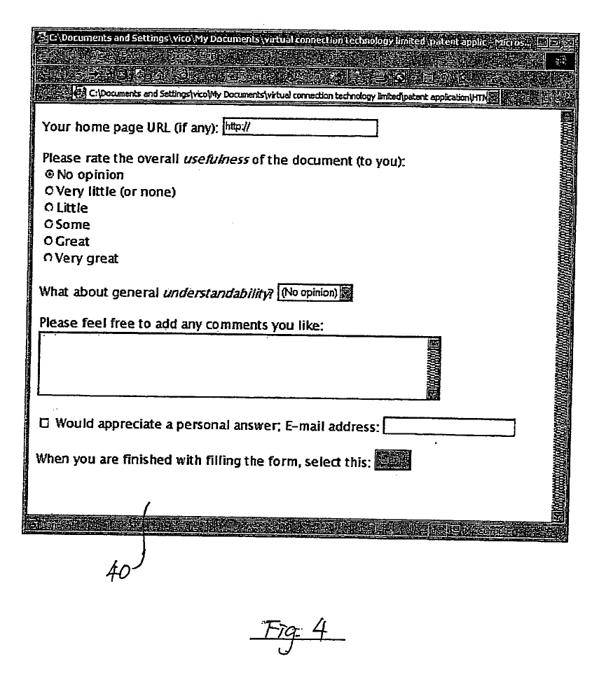

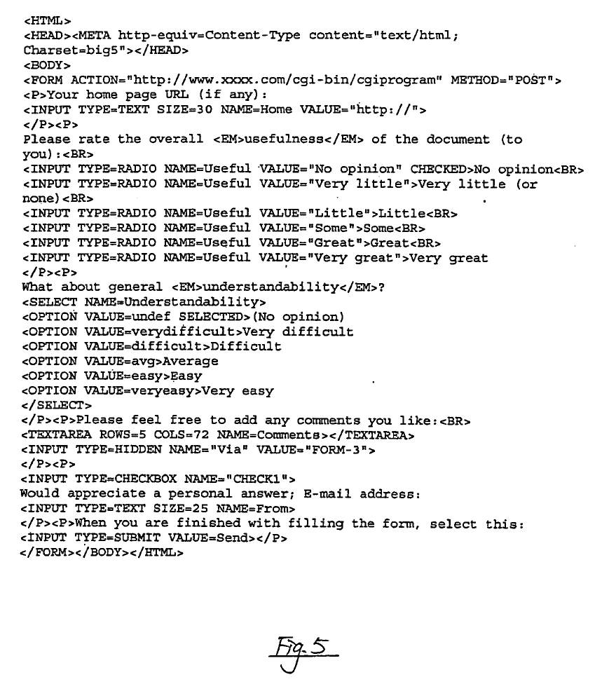

FIG. 4 shows a sample HTML form 40 displayed in a browser, which acts as a graphic user interface. The most common browsers are Microsoft Internet Explorer™ from Microsoft Corporation and Netscape Navigator™ from Netscape Communications Corporation, which are both graphical browsers, which means they can display graphics and text. It can be seen that the fields in the form 40 can be readily understood by human beings. The text source of this sample form 40 is shown in FIG. 5, which can be readily read and interpreted by an application program.

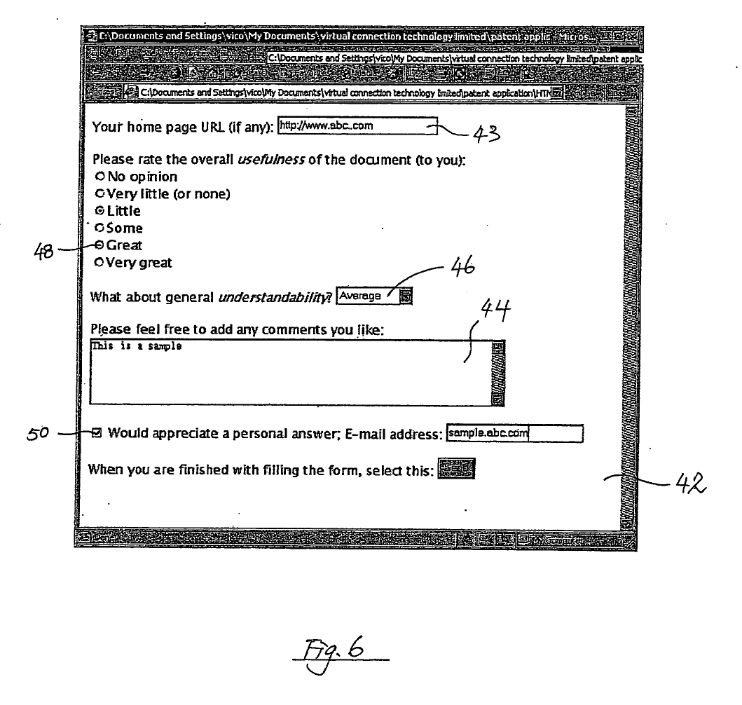

A user may enter various data and information into the form 40, e.g. as in the completed form 42 shown in FIG. 6. This can be done by inputting text in a text field 43 or text area 44, select an option in a drop down box 46, click a radio button 48 or checkbox 50. FIG. 7 shows the HTML source of the completed form 42, in which the changes made to the form 40 are highlighted.

In this invention, a client side program works like a dedicated editor, reads the source HTML form page, displays the HTML form to the user, allows the user to change field values and then to save it as a new HTML form p age. To facilitate program processing, system information, e.g. user identify (ID) and system date/time, are encoded and stored as hidden fields in the HTML form. The system also allows the user to send this filled-in HTML form page to others by e-mail, instant message system or even physical media offline.

As shown and discussed above, this invention provides a system and method to develop peer to peer application which allows users to exchange information using HTML form pages, in the absence of web server and server side programs. A typical example of peer to peer application model may include the following steps:
a. a first user uses the software program according to this invention to create a questionnaire in HTML format, which contains data fields defined by the first user and system control information added by the system;
b. the first user saves and/or sends the generated HTML page to a second user for input of data;
c. the second user opens the HTML page with the software program according to this invention in his/her computer, and enters the requested information;
d. the second user saves and/or returns the completed/filled-in HTML page to the first user;
e. the first user reads the inputted information in the completed/filled-in HTML page and/or extracts data to other application(s), e.g. MS Excel.

This invention may be implemented as a plug-in program residing on the web browser or a Java applet downloaded from a URL, ActiveX run on top of a web browser, or a standalone application. In this connection, an “applet” is a program designed to be executed from within another application. Unlike an ordinary application, applets cannot be executed directly from the operating system. Web browsers equipped with Java virtual machines, can interpret applets from Web servers. Because applets are small in file size, cross-platform compatible, and highly secure, they are ideal for small Internet applications accessible from a browser. As to “ActiveX”, such is a set of technologies developed by Microsoft. An “ActiveX control” is a control using ActiveX technologies. An ActiveX control can be automatically downloaded and executed by a Web browser. ActiveX is not a programming language, but rather a set of rules for how applications should share information. Programmers can develop ActiveX controls in a variety of languages, including C, C++, Visual Basic, and Java. While ActiveX control is similar to a Java applet, ActiveX controls have full access to the Windows operating system, which gives them much more power than Java applets.

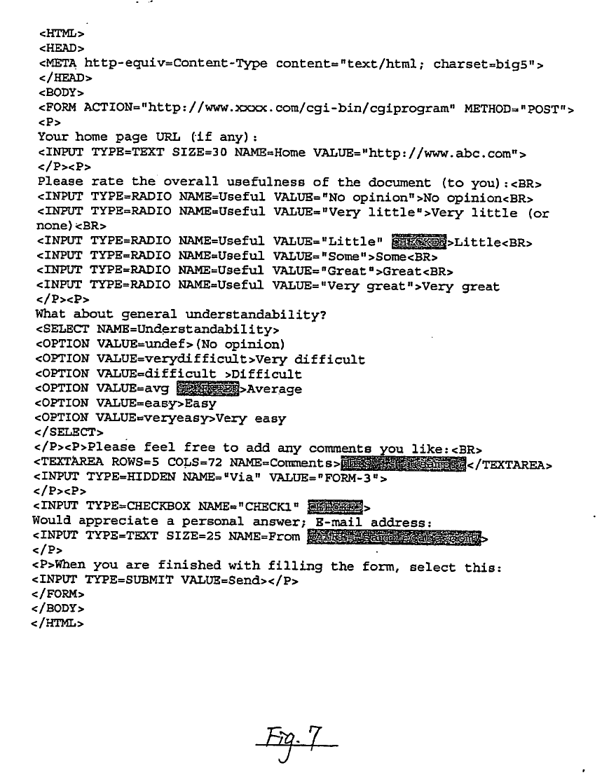

As shown in FIG. 8, a computer program according to the present invention may be implemented as a browser companion. The program will add some buttons to the toolbar of the Internet Explorer™, so that a user can run the application Component Object Model (COM) objects with the click of a button. COM is a software architecture developed to build component-based applications. COM objects are discrete components, each with a unique identity, which expose interfaces that allow applications and other components to access their features. ActiveX is also based on COM. The HTML page is used for carrying all necessary information related to processing of the application. No other means like cookies or environment variables related to HTTP protocol are used in this method. The limitations of HTTP protocol are thus avoided, and both online and offline processing are supported by this method. This invention also provides functionality to integrate external technology, thus providing opportunity for better automation.

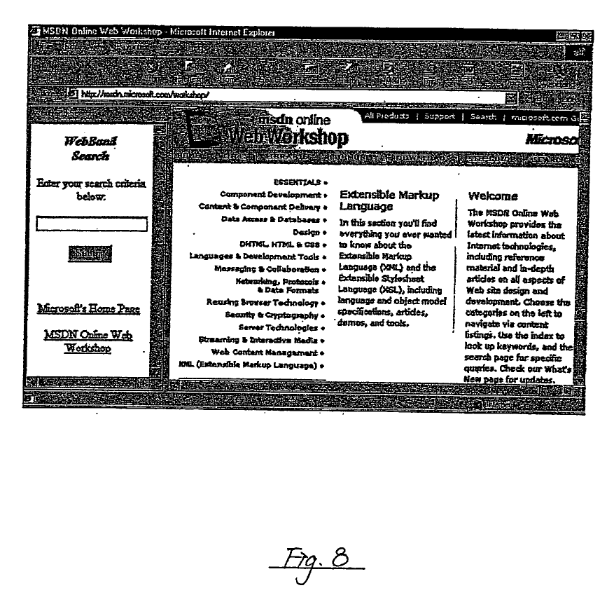

Turning now to FIG. 9, such shows the functions which may be carried out in a method and computer program according to the present invention. As can be seen, a first module provided is a “Template Builder” 50, allowing insertion of HTML components 52, and editing of HTML page 54. The HTML components which may be inserted into an HTML page include form items 56, e.g. text boxes, text areas, radio buttons, selection boxes, etc., and such other items as images and URLs 58. A second module provided is “Process System Information” 60, which includes addition of digital signature 62, display of form control information 64 and verification of digital signature of form 66. A third module of the method and computer program is “Process HTML Page” 68, with three main functions, namely “Open HTML page” 70, “Close HTML page” 72 and “Export form information” 74. The functions which may be performed under the main function “Open HTML page” 70 include “Open Current navigated HTML page” 76, “Retrieve HTML form from template” 78, “Open HTML form from local hardisk” 80. Finally, the functions which may be performed under the main function “Close HTML page” 72 include “Save HTML page to local hardisk” 82 and “Send current HTML page by eMail” 84.

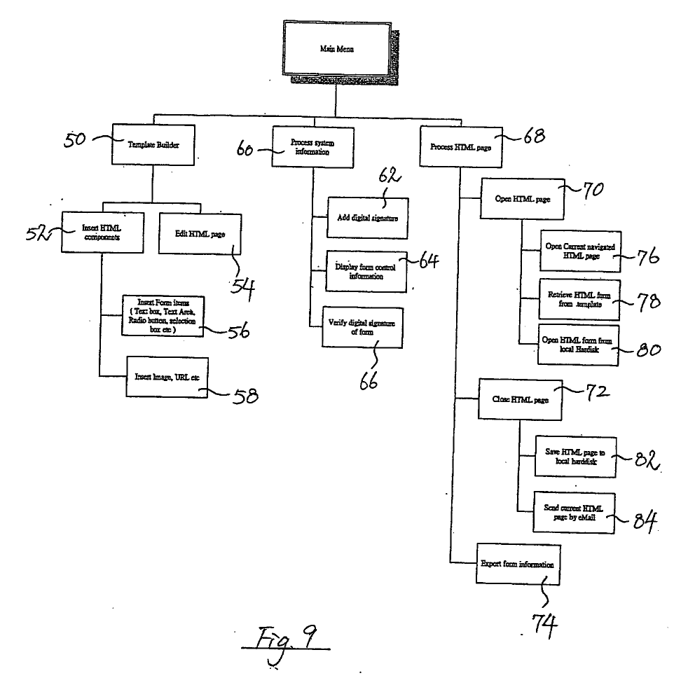

For carrying out the step “Insert HTML components” 52 mentioned above, and as shown in FIG. 10, a web browser is used for opening the HTML page (Step 86). The user then obtains references to the objects that represent the HTML elements on the HTML page through the document object (Step 88). When the user clicks an “insert” button, the relevant insert HTML sub-menu will be displayed (Step 90). The user then inputs the relevant data and, based on the inserted data, the program will add attributes to the document object (Step 92). The program will also refresh the HTML page with the modified document object(s) (Step 94).

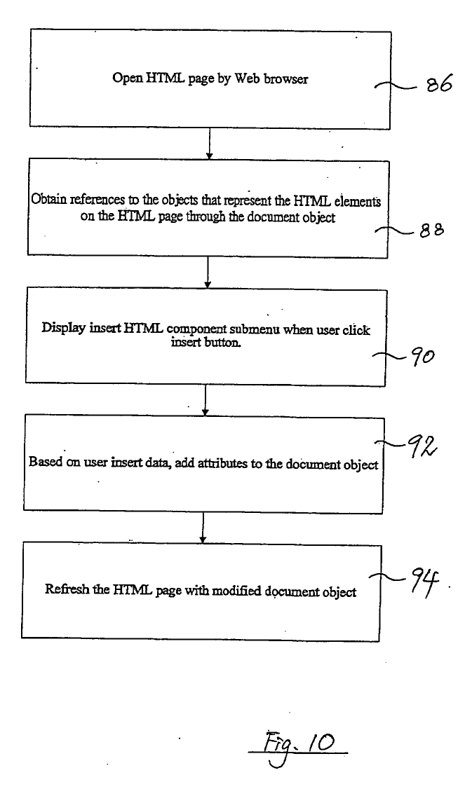

Turning now to FIG. 11, such shows the steps for validating and saving HTML pages created in accordance with a method and by a program according to the present invention. A user first opens an HTML page with a web browser (Step 96). The user then obtains references to the objects that represent the HTML elements on the HTML page through the document object (Step 98). When the user presses a “Save” button, a validation method is called into play (Step 100). The validation method uses the properties and collections of the document object to access all the objects in the Dynamic HTML (DHTML) Object Model, including the window object and all element objects (Step 102). The user may use the <FORM> tag to access intrinsic controls, such as text boxes, check boxes, radio buttons, and submit buttons in the HTML form (Step 104). With such objects, one can obtain the data entered by the user and validate such data. The elements collection can be used to obtain a reference to a specific object in the form by specifying the object's ID (Step 106). After validation of the data, and if everything is checked to be property entered, a “TRUE” is returned from the event handler (Step 108).

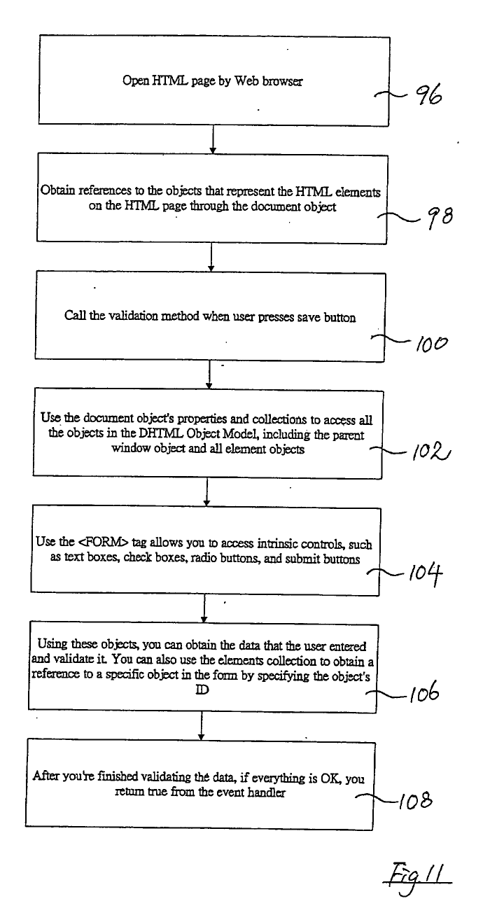

As shown in FIG. 12, when a user (form creator) wants to create a new file, the method or compute program according to this invention will start (Step 148) by opening an HTML form file (Step 150). The system will then ask the user whether a new HTML form is to be created (Step 152). If the answer is in the affirmative, a blank HTML form will be created with standard header and footer (Step 154). After creation of this blank HTML form or if the answer to the query in Step 152 above is in the negative, the system will receive further input from the user in an interactive manner (Step 156). The system will then see if the user inserts or updates form fields, e.g. to see if the user presses a field insert or update button (Step 158). If not, the system will keep on receiving further input from the user in an interactive manner (Step 156). If, on the other hand, the user does insert or update form fields, a screen, called “Field Property Screen”, will be displayed (Step 160), e.g. on a visual display unit (VDU), such as a monitor, to allow the user to input the properties of form fields, e.g. text field, radio button or selection box.

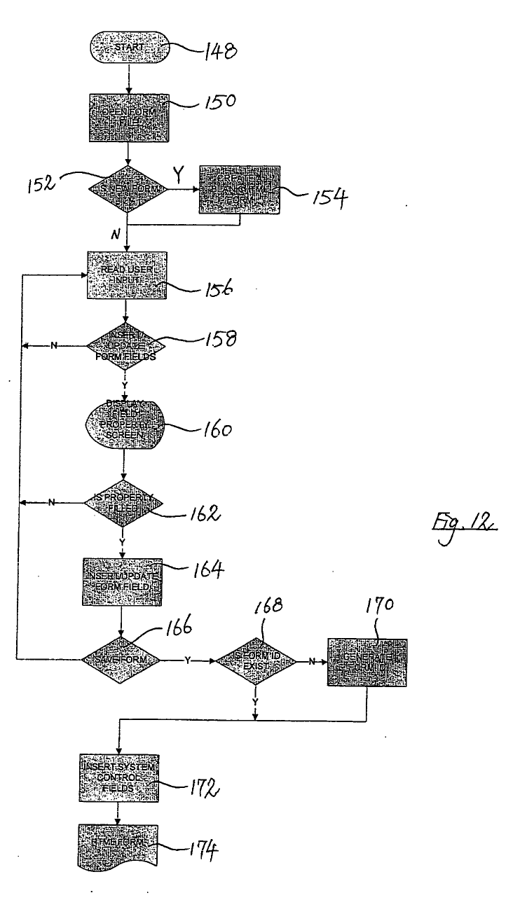

The system will then check whether all necessary field information has been provided by the user (Step 162). If not, the system will keep on receiving further input from the user in an interactively (Step 156). If, on the other hand, all necessary field information has been provided by the user, the system will use the property values inputted by the user to format a string according to HTML forms standard, e.g. as shown in FIG. 21, and insert this string into the HTML form file (Step 164). An exemplary HTML form so created is shown in FIG. 13, and corresponding syntax/source of the form fields is shown in FIG. 14.

The system will then ask whether the user wishes to store the form (Step 166). If not, the system will keep on receiving further input from the user in an interactive manner (Step 156). If, on the other hand, the user indicates that the form is to be stored, a Form ID will be requested to be inputted. A Form ID is a unique reference of a blank HTML form. Form ID can be used for identifying the filled-in form and grouping data from forms with the same Form ID. The system will then check whether the inputted Form ID already exists (Step 168). If the inputted Form ID is not already in existence, a new Form ID will be generated (Form 170). The Form ID may be a digital signature of the HTML form, or a result of MD5, SHA1 or CRC functions. If, on the other hand, the Form ID already exists or if a new Form ID is generated, the system will record the input user information, system date time, etc. as system control information (Step 172), to be encoded as a hidden field. As shown in FIG. 14, two hidden fields are encoded in the HTML form. After the form creation process is completed, an HTML form file is created and stored (Step 174).

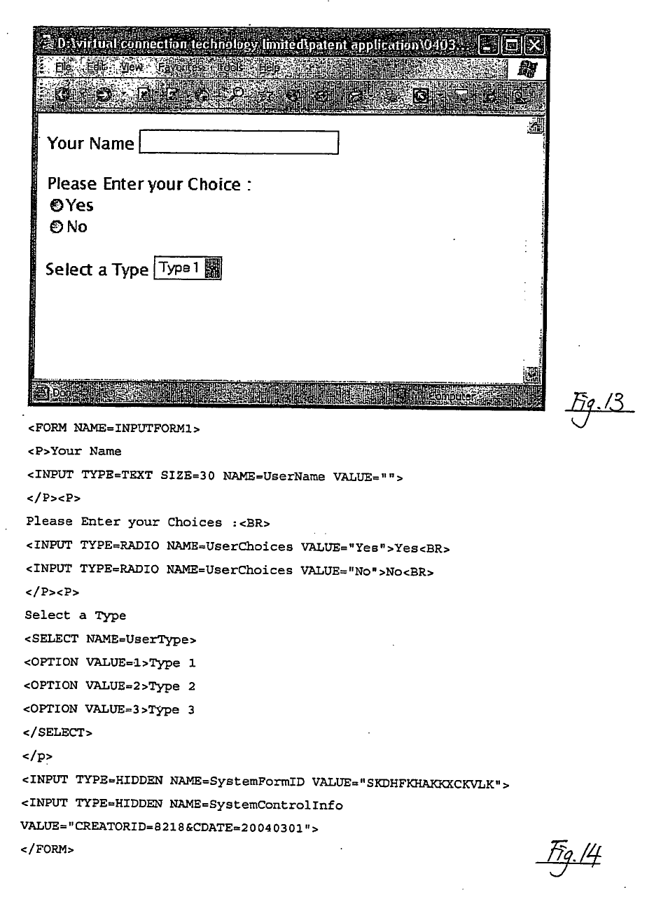

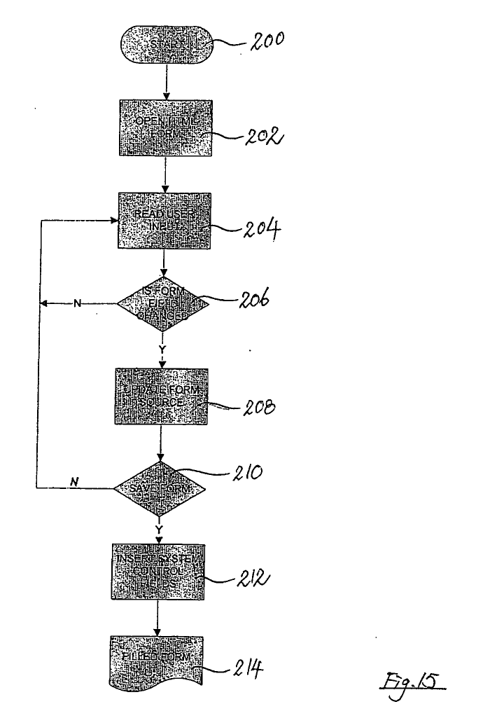

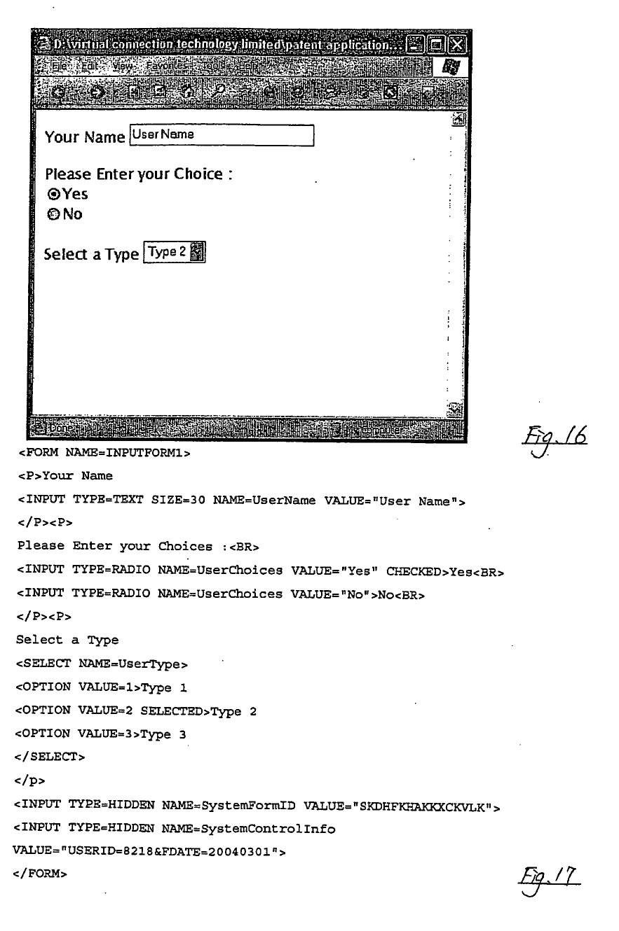

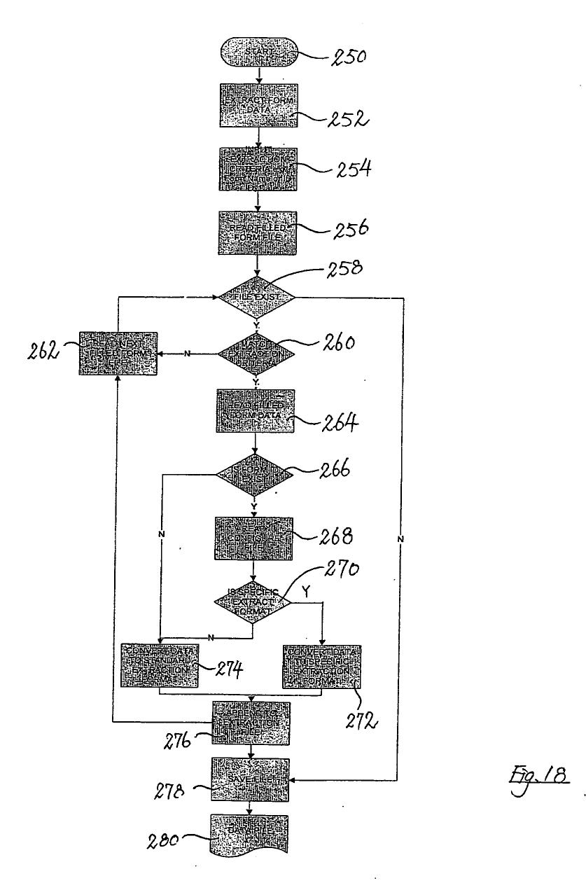

Turning now to FIG. 15, when a user (form filler) wants to fill in an HTML form created in accordance with the invention, the process starts (Step 200) by the user opening and reading the relevant HTML form file (Step 202). The system will then work interactively with the user, in particular to read data and information inputted by the user (Step 204). The system will then see whether the user enters form data and whether the form fields are changed (Step 206). If not, the system will keep on reading the data and information inputted by the user (Step 204). If, on the other hand, the form fields are changed, the system will use the values inputted by the user to update the field string according to HTML forms standard (Step 208), e.g. as shown in FIG. 21, and have it inserted into the HTML form file. An exemplary HTML form so filled in is shown in FIG. 16, and corresponding syntax/source of the changed form fields is shown in FIG. 17.

The system will ask the user whether the filled-in HTML form is to be stored (Step 210). If not, the system will keep on reading the data and information inputted by the user (Step 204). If, on the other hand, the user indicates that the filled-in HTML form is to be stored, the system will record the input user information, system date time, etc. as system control information (Step 212), to be encoded as a hidden field. A filled form is thus created and stored (Step 214).

When a number of filled-in HTML forms are received, a user (data collector) may extract the data entered into such HTML forms. Such a process starts (Step 250) by extracting data from a number of such filled-in HTML form files (Step 252). The system will allow, e.g. by providing a screen, the user to input extraction criterion/criteria, which may be one or more of form name, Form ID, system date, or User ID (Step 254). This criterion/criteria will be used as a filter for selecting the relevant form files. The system will then search for filled-in HTML form files located in various data sources, e.g. from the Internet or intranet, in the local file directory or e-mail folders (Step 256). The system will first check whether there are any HTML form files in such data sources (Step 258). If so, it will then check whether such HTML form files match the extraction criterion/criteria (Step 260). If not, it will read the next filled form file (Step 262). If, on the other hand, the files match the extraction criterion/criteria, the system will read the data entered into the HTML form file (Step 264).

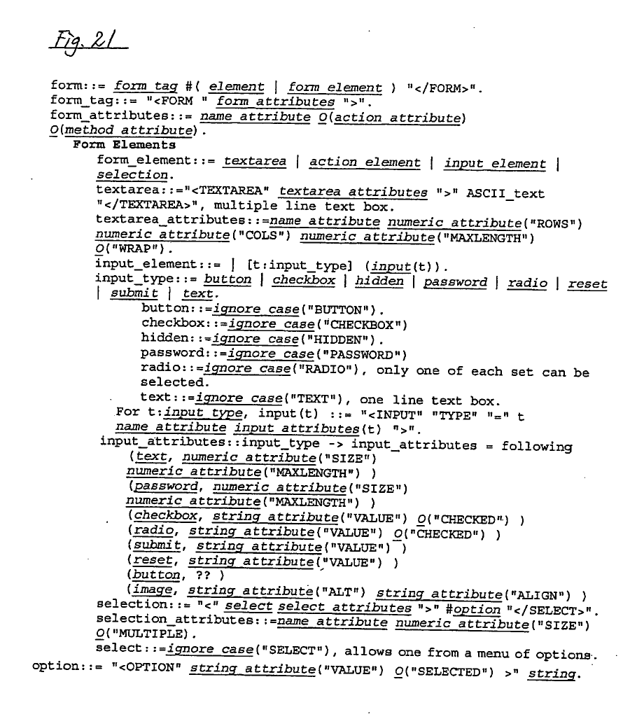

The system will then check whether the Form ID of the HTML form file already exists (Step 266). If so, the system will read from a configuration file (Step 268) which contains the specific instruction(s) to convert the form data. The Form ID is the key to locate records for specific HTML form. The system will then check whether a record exists in the configuration file with the same Form ID (Step 270). If so, form data will be extracted and converted according to the specific instruction(s), e.g. into CVS or MS Excel format (Step 272). If, on the other hand, no record exists in the configuration file with the same Form ID, the form data will be extracted and converted into standard XML format (Step 274), such as the one shown in FIG. 20. Data extracted from various HTML forms with the same Form ID will be merged into a single file (Step 276). The extraction file will then be saved (Step 278), and a data file created (Step 280).

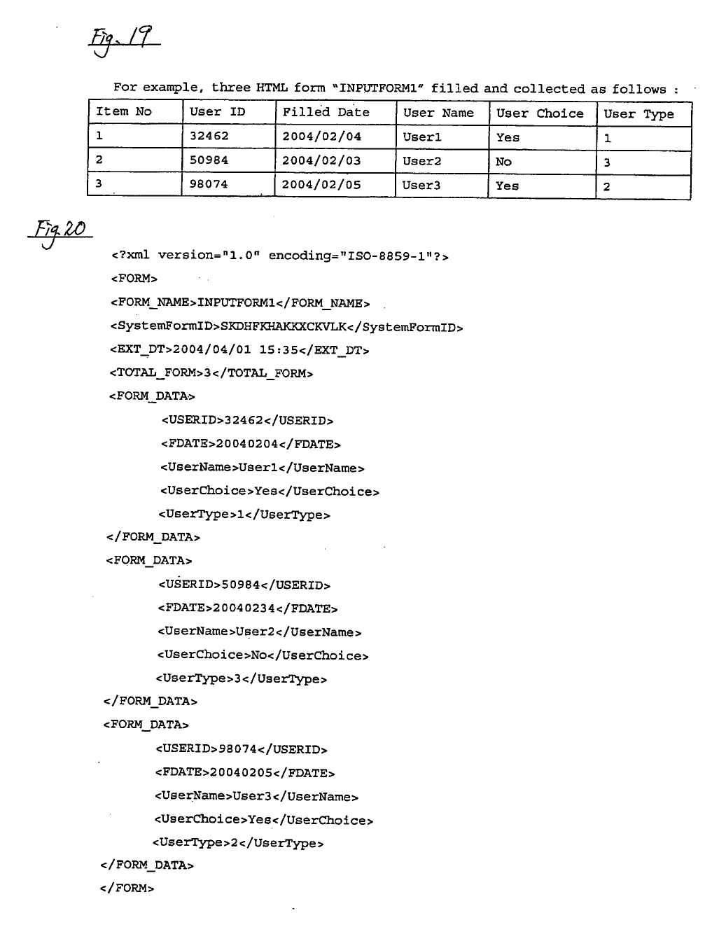

FIG. 19 shows data collected from three forms, all of the same Form ID, namely “INPUTFORM1”, in table form. Form 20 shows the data so collected as being converted into standard XML format. As to FIG. 21, such shows a simplified syntax of an HTML form.

It should course be understood that the creation, filling in, and storing of an HTML form in accordance with this invention may all be implemented by way of a computer program, executable to carry out the steps discussed above and shown in the accompanying drawings.

It should be understood that the above only illustrates examples whereby the present invention may be carried out, and that various modifications and/or alterations may be made thereto without departing from the spirit of the invention. It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A method of creating an HTML document allowing input of data, including the steps of:
providing a blank editable HTML document carrying at least a piece of editable information;
editing said HTML document by editing said piece of editable information; and
storing said edited HTML document.

2. A method according to claim 1 wherein said HTML document is created on a data processing apparatus offline from a server.

3. A method according to claim 1 further including a step of providing a graphic user interface on a visual display unit.

4. A method according to claim 1 further including a step of generating system control information.

5. A method according to claim 4 further including a step of encoding said system control information.

6. A method according to claim 5 further including a step of creating at least one hidden field in said HTML document containing said encoded system control information.

7. A method according to claim 4 wherein said system control information includes at least one of form ID, creator ID, digital signature, and form creation date/time.

8. A method according to claim 1 wherein said method being carried out by a client-side computer program.

9. A method according to claim 8 wherein said computer program is executable on top of a web browser.

10. A method according to claim 1 further including a step of adding encryption information.

11. A method according to claim 1 wherein said edited HTML document is stored in a client-side machine, a file server, a removable data storage media.

12. A method according to claim 1 including a step of transmitting said edited HTML document via e-mail.

13. A method according to claim 1 wherein said HTML document is an HTML form.

14. A method according to claim 1 wherein said editable information comprises a form field.

15. A method according to claim 14 wherein said step of editing said HTML form comprises changing said form field or inputting a second form field.

16. A computer program loadable into a data processing apparatus and executable to carry out the method according to claim 1.

17. A method of inputting data into an HTML document carrying at least a piece of editable information, including the steps of:
opening said HTML document;
entering data into said HTML document; and
changing the source of said HTML document in accordance with the data inputted into said HTML document.

18. A method according to claim 17 further including a step of storing said edited HTML document with the changed source.

19. A method according to claim 18 further including a step of recording at least one of input user ID and system date time.

20. A method according to claim 17 further including steps of monitoring the data inputted into said HTML document, validating said data against pre-set criteria in hidden fields in said HTML document, and outputting a prompt to a user if said inputted data do not fulfill said pre-set criteria.

21. A method according to claim 17 further including a step of allowing a user to input information for subsequent encoding and storage in new hidden fields in said HTML document.

22. A method according to claim 17 further including a step of encrypting said filled-in HTML document.

23. A method according to claim 17 wherein said HTML document is opened and read by a web browser.

24. A method according to claim 23 wherein said web browser is installed on a client-side data processing apparatus.

25. A method according to claim 17 wherein said HTML document is an HTML form with at least one form field.

26. A method according to claim 25 wherein said step of entering data into said HTML document is effected in accordance with said at least one form field.

27. A computer program loadable into a data processing apparatus and executable to carry out the method according to claim 17.

28. A method of extracting data inputted into a plurality of HTML forms, including the steps of:
receiving said plurality of filled-in HTML forms each with at least one filled-in form field;
setting at least one criterion for selection of filled-in HTML forms;
sorting said plurality of filled-in HTML forms on the basis of said at least one criterion; and
reading and extracting said data in said filled-in HTML forms which fulfill said sorting criterion.

29. A method according to claim 28 further including a step of generating at least one data file on the basis of said data extracted from said filled-in HTML forms which fulfill said at least one criterion.

30. A method according to claim 29 wherein said data file is in MS Excel or CVS format.

31. A method according to claim 29 further including a step of looking up a configuration file to determine the format of said data file.

32. A method according to 28 wherein said at least one criterion is the Form ID.

33. A computer program loadable into a data processing apparatus and executable to carry out the method according to claim 28.
